(19) United States
(12) Patent Application Publication
(10) Pub. No.: US 2004/0054000 A1
(43) Pub. Date: Mar. 18, 2004

(54) Fungicidal compositions containing a benzophenone and an oxime ether derivative

(76) Inventors: Karl Eicken, Wachenheim (DE); Ingo Rose, Mannheim (DE); Eberhard Ammermann, Heppenheim (DE); Reinhard Stierl, Mutterstadt (DE); Gisela Lorenz, Hambach (DE); Siegfried Strathmann, Limburgerhof (DE); Maria Scherer, Landau (DE); Klaus Schelberger, Gonnheim (DE); Egon Haden, Kleinniedesheim (DE)

Correspondence Address: KEIL & WEINKAUF, 1350 CONNECTICUT AVENUE, N.W., WASHINGTON, DC, 20036, US

(21) Appl. No.: 10/466,332

(22) PCT Filed: Jan. 17, 2002
(86) PCT No.: PCT/EP02/00414

(30) Foreign Application Priority Data
Jan. 18, 2001 (DE) 101 02 281.6

(51) Int. Cl. A01N 37/34; A01N 37/18; A01N 35/00

(52) U.S. Cl. 514/521; 514/625; 514/687

(57) ABSTRACT

Fungicidal mixtures, comprising

a) benzophenones of the formula I

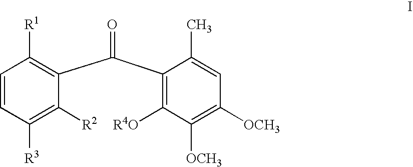

in which

R¹ is chlorine, methyl, methoxy, acetoxy, pivaloyloxy or hydroxyl;

R² is chlorine or methyl;

R³ is hydrogen, halogen or methyl; and

R⁴ is C₁-C₆-alkyl or benzyl, where the phenyl moiety of the benzyl radical may carry a halogen or methyl substituent, and

b) oxime ether derivatives of the formula II

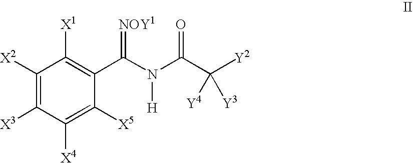

where the substituents X¹ to X⁵ and Y¹ to Y⁴ are as defined in the description;

in a synergistically effective amount, methods for controlling harmful fungi using mixtures of the compounds I and II and compositions comprising them are described.

The present invention relates to fungicidal mixtures, comprising

a) benzophenones of the formula I

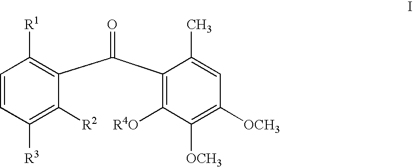

in which

R¹ is chlorine, methyl, methoxy, acetoxy, pivaloyloxy or hydroxyl;

R² is chlorine or methyl;

R³ is hydrogen, halogen or methyl; and

R⁴ is Cₗ-C₆-alkyl or benzyl, where the phenyl moiety of the benzyl radical may carry a halogen or methyl substituent, and

b) oxime ether derivatives of the formula II

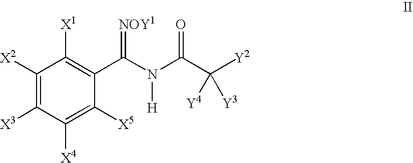

where the substituents X¹ to X⁵ and Y¹ to Y⁴ are as defined below:

X¹ is halogen, C₁-C₄-haloalkyl or C₁-C₄-haloalkoxy;

X² to X⁵ independently of one another are hydrogen, halogen, C₁-C₄-alkyl, C₁-C₄-haloalkyl, C₁-C₄-alkoxy or C₁-C₄-haloalkoxy;

Y¹ is C₁-C₄-alkyl, C₂-C₆-alkenyl, C₂-C₆-alkynyl, C₁-C₄-alkyl-C₃-C₇-cycloalkyl, where these radicals may carry substituents selected from the group consisting of halogen, cyano and C₁-C₄-alkoxy;

Y² is a phenyl radical or a 5- or 6-membered saturated or unsaturated heterocyclyl radical having at least one heteroatom selected from the group consisting of N, O and S, where the cyclic radicals may have one to three substituents selected from the group consisting of halogen, C₁-C₄-alkyl, C₁-C₄-alkoxy, C₁-C₄-haloalkyl, C₁-C₄-haloalkoxy, C₁-C₄-alkoxy-C₂-C₄-alkenyl, C₁-C₄-alkoxy-C₂-C₄-alkynyl; and

Y³, Y⁴ independently of one another are hydrogen, C₁-C₄-alkyl, C₁-C₄-alkoxy, C₁-C₄-alkylthio, N-C₁-C₄-alkylamino, C₁-C₄-haloalkyl or C₁-C₄-haloalkoxy;

in a synergistically effective amount.

Moreover, the invention relates to methods for controlling harmful fungi using mixtures of the compounds I and II and to the compositions comprising the compounds I and II.

The compounds of the formula I, their preparation and their action against harmful fungi are known from the literature (EP-A 727 141; EP-A 897 904; EP-A 899 255; EP-A 967 196).

Mixtures of benzophenones of the formula I with other fungicidally active compounds are known from EP-A 1 023 834.

The compounds of the formula II and processes for their preparation are described in WO-A 96/19442, EP-A 1 017 670 and EP-A 1 017 671.

DE-A 197 22 223 describes mixtures of compounds of the formula II and active compounds from the class of the Strobilurins.

It is an object of the present invention to provide further particularly effective mixtures for controlling harmful fungi and in particular for certain indications.

It is an object of the present invention to provide mixtures which have an improved activity against harmful fungi, combined with a reduced total amount of active compounds applied (synergistic mixtures), with a view to reducing the application rates and improving the activity spectrum of the known compounds I and II.

We have found that this object is achieved by the mixtures defined at the outset. Moreover, we have found that applying the compounds I and the compounds II simultaneously, i.e. together or separately, or applying the compounds I and the compounds II successively provides better control of harmful fungi than is possible with the individual compounds alone.

The mixtures according to the invention act synergistically and are therefore particularly suitable for controlling harmful fungi and in particular powdery mildew fungi in cereals, vegetables, fruit, ornamental plants and grapevines.

The following compounds of the formula I are preferred mixing partners, the individual preferences applying on their own and in combination.

Preference is given to compounds I in which R¹ is chlorine, methoxy, acetoxy or hydroxyl, and particular preference is given to compounds in which R¹ is methoxy, acetoxy or hydroxyl. Very particular preference is given to compounds in which R¹ is methoxy.

Mixtures comprising compounds I in which R² is chlorine or methyl are mixtures according to the invention. Preference is given to compounds I in which R² is methyl.

Moreover, preference is given to compounds I in which R³ is hydrogen, methyl, chlorine or bromine, and with particular preference hydrogen, chlorine or bromine.

In addition, preference is given to compounds I in which R⁴ is C₁-C₄-alkyl or benzyl, where the phenyl moiety of the benzyl radical may carry a halogen or methyl substituent. Particularly preferred are compounds of the formula I in which R⁴ is C₁-C₄-alkyl, preferably methyl.

Furthermore preferred are compounds of the formula I in which the substituents R¹, R², R³ and R⁴ are as defined below:

R¹ is methoxy, acetoxy or hydroxyl;

R² is methyl;

R³ is hydrogen, chlorine or bromine; and

R⁴ is C₁-C₄-alkyl.

In addition, particular preference is given to compounds of the formula I in which the substituents are as defined in Table 1 below:

| | |
|---|---|
| | I |
| 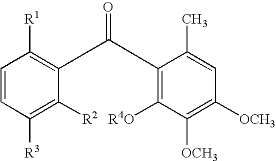 | |

| No. | R¹ | R² | R³ | R⁴ |
|---|---|---|---|---|
| I-1 | methoxy | Cl | H | methyl |
| I-2 | methoxy | Cl | methyl | methyl |
| I-3 | methoxy | Cl | H | n-propyl |
| I-4 | methoxy | Cl | H | n-butyl |
| I-5 | methoxy | Cl | H | benzyl |
| I-6 | methoxy | Cl | H | 2-fluorobenzyl |
| I-7 | methoxy | Cl | H | 3-fluorobenzyl |
| I-8 | methoxy | Cl | H | 4-fluorophenyl |
| I-9 | methoxy | Cl | H | 2-methylphenyl |
| I-10 | methoxy | Cl | H | 3-methylphenyl |
| I-11 | methoxy | Cl | H | 4-methylphenyl |
| I-12 | methoxy | Cl | Br | methyl |
| I-13 | methoxy | Cl | Br | n-propyl |
| I-14 | methoxy | Cl | Br | n-butyl |
| I-15 | methoxy | Cl | Br | benzyl |
| I-16 | methoxy | Cl | Br | 2-fluorobenzyl |
| I-17 | methoxy | methyl | H | methyl |
| I-18 | methoxy | methyl | Cl | methyl |
| I-19 | methoxy | methyl | H | n-propyl |
| I-20 | methoxy | methyl | H | n-butyl |
| I-21 | methoxy | methyl | H | benzyl |
| I-22 | methoxy | methyl | H | 2-fluorobenzyl |
| I-23 | methoxy | methyl | H | 3-fluorobenzyl |
| I-24 | methoxy | methyl | H | 4-fluorophenyl |
| I-25 | methoxy | methyl | H | 2-methylphenyl |
| I-26 | methoxy | methyl | H | 3-methylphenyl |
| I-27 | methoxy | methyl | H | 4-methylphenyl |
| I-28 | methoxy | methyl | Br | methyl |
| I-29 | methoxy | methyl | Br | n-propyl |
| I-30 | methoxy | methyl | Br | n-butyl |
| I-31 | methoxy | methyl | Br | benzyl |
| I-32 | methoxy | methyl | Br | 2-fluorobenzyl |
| I-33 | acetoxy | methyl | H | methyl |
| I-34 | acetoxy | methyl | Cl | methyl |
| I-35 | acetoxy | methyl | Br | methyl |
| I-36 | hydroxy | methyl | H | methyl |
| I-37 | hydroxy | methyl | Cl | methyl |
| I-38 | hydroxy | methyl | Br | methyl |
| I-39 | pivaloyloxy | methyl | H | methyl |
| I-40 | pivaloyloxy | methyl | Cl | methyl |
| I-41 | pivaloyloxy | methyl | Br | methyl |
| I-42 | Cl | Cl | H | methyl |
| I-43 | Cl | Cl | H | n-propyl |
| I-44 | Cl | Cl | H | n-butyl |
| I-45 | Cl | Cl | H | benzyl |
| I-46 | Cl | Cl | H | 2-fluorobenzyl |
| I-47 | Cl | Cl | H | 3-fluorobenzyl |
| I-48 | Cl | Cl | H | 4-fluorophenyl |
| I-49 | Cl | Cl | H | 2-methylphenyl |
| I-50 | Cl | Cl | H | 3-methylphenyl |
| I-51 | Cl | Cl | H | 4-methylphenyl |
| I-52 | Cl | Cl | Br | methyl |
| I-53 | Cl | Cl | Br | n-propyl |
| I-54 | Cl | Cl | Br | n-butyl |
| I-55 | Cl | Cl | Br | benzyl |
| I-56 | Cl | Cl | Br | 2-fluorobenzyl |
| I-57 | methyl | methyl | H | methyl |
| I-58 | methyl | methyl | H | n-propyl |
| I-59 | methyl | methyl | H | n-butyl |
| I-60 | methyl | methyl | H | benzyl |
| I-61 | methyl | methyl | H | 2-fluorobenzyl |
| I-62 | methyl | methyl | H | 3-fluorobenzyl |
| I-63 | methyl | methyl | H | 4-fluorophenyl |
| I-64 | methyl | methyl | H | 2-methylphenyl |
| I-65 | methyl | methyl | H | 3-methylphenyl |
| I-66 | methyl | methyl | H | 4-methylphenyl |
| I-67 | methyl | methyl | Br | methyl |
| I-68 | methyl | methyl | Br | n-propyl |
| I-69 | methyl | methyl | Br | n-butyl |
| I-70 | methyl | methyl | Br | benzyl |
| I-71 | methyl | methyl | Br | 2-fluorobenzyl |

Mixing components b) are the oxime ether derivatives of the formula II

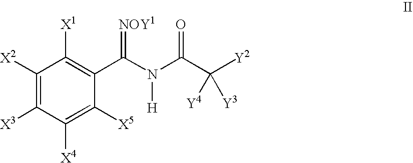

where the substituents X¹ to X⁵ and Y¹ to Y⁴ are as defined below:

X¹ is halogen, C₁-C₄-haloalkyl or C₁-C₄-haloalkoxy;

X² to X⁵ independently of one another are hydrogen, halogen, C₁-C₄-alkyl, C₁-C₄-haloalkyl, C₁-C₄-alkoxy or C₁-C₄-haloalkoxy;

Y¹ is C₁-C₄-alkyl, C₂-C₆-alkenyl, C₂-C₆-alkynyl, C₁-C₄-alkyl-C₃-C₇-cycloalkyl, where these radicals may carry substituents selected from the group consisting of halogen, cyano and C₁-C₄-alkoxy;

Y² is a phenyl radical or a 5- or 6-membered saturated or unsaturated heterocyclyl radical having at least one heteroatom selected from the group consisting of N, O and S, where the cyclic radicals may have one to three substituents selected from the group consisting of halogen, C₁-C₄-alkyl, C₁-C₄-alkoxy, C₁-C₄-haloalkyl, C₁-C₄-haloalkoxy, C₁-C₄-alkoxy-C₂-C₄-alkenyl, C₁-C₄-alkoxy-C₂-C₄-alkynyl; and

Y³, Y⁴ independently of one another are hydrogen, C₁-C₄-alkyl, C₁-C₄-alkoxy, C₁-C₄-alkylthio, N-C₁-C₄-alkylamino, C₁-C₄-haloalkyl or C₁-C₄-haloalkoxy.

Among the compounds II, preference is given to those in which

X¹ is chlorine, difluoromethoxy or trifluoromethyl;

X² and X³ are hydrogen;

X⁴ is hydrogen or fluorine;

X⁵ is chlorine, fluorine, trifluoromethyl or difluoromethoxy;

Y¹ is methylenecyclopropyl;

Y² is unsubstituted or substituted phenyl, thienyl, pyrazolyl, pyrrolyl, imidazolyl, thiazolyl, furyl, pyridazinyl or pyrimidinyl. Preferred substituents on these ring systems are halogen (in particular F and Cl),

C₁-C₄-alkoxy (in particular methoxy) and C₁-C₄-alkyl (in particular methyl). The number of ring substituents may be from 1 to 3, in particular 1 or 2. Unsubstituted phenyl or phenyl which is substituted in the 4-position by fluorine, methyl, trifluoromethyl or methoxy are particularly preferred;

Y³ and Y⁴ are hydrogen.

Preferred compounds of the formula II are compiled in Table 2 below.

TABLE 2

| | |
|---|---|
| | II.1 |
| 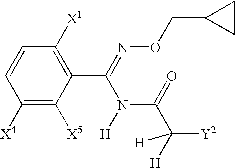 | |

| No. | X¹ | X⁴ | X⁵ | Y² |
|---|---|---|---|---|
| II-1 | Cl | H | F | Ph |
| II-2 | Cl | H | F | Ph-2-F |
| II-3 | Cl | H | F | Ph-2,4-F₂ |
| II-4 | Cl | H | F | Ph-2-F-3-Me |
| II-5 | Cl | H | F | Ph-2-F-4-OMe |
| II-6 | Cl | H | F | Ph-3,5-Me₂ |
| II-7 | Cl | H | F | 3-methylpyrazol-1-yl |
| II-8 | Cl | H | F | 3-methyl-2-thienyl |
| II-9 | Cl | H | F | 2-thienyl |
| II-10 | Cl | H | Cl | Ph |
| II-11 | Cl | H | Cl | Ph-2, 4-F₂ |
| II-12 | Cl | H | CF₃ | 2-thienyl |
| II-13 | Cl | H | CF₃ | Ph-4-Me |
| II-14 | Cl | H | CF₃ | Ph-4-OMe |
| II-15 | Cl | H | CF₃ | Ph |
| II-16 | OCHF₂ | H | F | Ph |
| II-17 | OCHF₂ | H | F | Ph-2-F |
| II-18 | OCHF₂ | H | F | Ph-4-F |
| II-19 | OCHF₂ | H | F | Ph-4-CF₃ |
| II-20 | OCHF₂ | H | F | Ph-4-OMe |
| II-21 | OCHF₂ | H | F | Ph-4-Me |
| II-22 | OCHF₂ | H | F | 3-methylpyrazol-1-yl |
| II-23 | OCHF₂ | H | F | 3-methyl-2-thienyl |
| II-24 | OCHF₂ | H | F | 2-thienyl |
| II-25 | OCHF₂ | H | Cl | Ph |
| II-26 | OCHF₂ | H | Cl | Ph-2,4-F₂ |
| II-27 | OCHF₂ | H | CF₃ | 2-thienyl |
| II-28 | OCHF₂ | H | CF₃ | Ph-4-Me |
| II-29 | OCHF₂ | H | CF₃ | Ph-4-OMe |
| II-30 | OCHF₂ | H | CF₃ | Ph |
| II-31 | OCHF₂ | H | OCHF₂ | Ph-4-OMe |
| II-32 | OCHF₂ | H | OCHF₂ | Ph |
| II-33 | OCHF₂ | H | OCHF₂ | Ph-4-Me |
| II-34 | OCHF₂ | H | OCHF₂ | Ph-4-Cl |
| II-35 | CF₃ | H | F | Ph |
| II-36 | CF₃ | H | F | Ph-2-F |
| II-37 | CF₃ | H | F | Ph-4-F |
| II-38 | CF₃ | H | F | Ph-4-Me |
| II-39 | CF₃ | H | F | Ph-4-OMe |
| II-40 | CF₃ | H | F | Ph-4-CF₃ |
| II-41 | CF₃ | H | F | 3-methylpyrazol-1-yl |
| II-42 | CF₃ | H | F | 3-methyl-2-thienyl |
| II-43 | CF₃ | H | F | 2-thienyl |
| II-44 | CF₃ | H | Cl | Ph |
| II-45 | CF₃ | H | Cl | Ph-2,4-F2 |
| II-46 | CF₃ | H | CF₃ | 2-thienyl |
| II-47 | CF₃ | H | CF₃ | Ph-4-Me |
| II-48 | CF₃ | H | CF₃ | Ph-4-OMe |
| II-49 | CF₃ | H | CF₃ | Ph |
| II-50 | CF₃ | H | OCHF₂ | Ph-4-OMe |
| II-51 | CF₃ | H | OCHF₂ | Ph |
| II-52 | CF₃ | H | OCHF₂ | Ph-4-Me |
| II-53 | CF₃ | H | OCHF₂ | Ph-4-Cl |
| II-54 | CF₃ | Cl | F | 2-thienyl |
| II-55 | CF₃ | Cl | F | Ph-2-F |
| II-56 | CF₃ | Cl | F | Ph |
| II-57 | CF₃ | Cl | F | Ph-2-F-5-Me |
| II-58 | CF₃ | Cl | Cl | Ph-3,5-Me₂ |
| II-59 | OCHF₂ | F | F | Ph |
| II-60 | OCHF₂ | F | F | 3-methylpyrazol-1-yl |
| II-61 | OCHF₂ | F | F | 3-methyl-2-thienyl |
| II-62 | OCHF₂ | F | F | Ph-4-Me |
| II-63 | OCHF₂ | F | F | Ph-2-F-4-OMe |
| II-64 | OCHF₂ | F | F | Ph-2-F-5-Me |
| II-65 | OCHF₂ | F | F | Ph-4-F |
| II-66 | OCHF₂ | F | F | Ph-4-CF₃ |
| II-67 | OCHF₂ | F | F | Ph-4-OMe |
| II-68 | OCHF₂ | F | F | Ph-4-Cl |
| II-69 | CF₃ | F | F | Ph |
| II-70 | CF₃ | F | F | 3-methylpyrazol-1-yl |
| II-71 | CF₃ | F | F | 3-methyl-2-thienyl |
| II-72 | CF₃ | F | F | Ph-4-Me |
| II-73 | CF₃ | F | F | Ph-2-F-4-OMe |
| II-74 | CF₃ | F | F | Ph-2-F-5-Me |
| II-75 | CF₃ | F | F | Ph-4-F |
| II-76 | CF₃ | F | F | Ph-4-CF₃ |
| II-77 | CF₃ | F | F | Ph-4-OMe |
| II-78 | CF₃ | F | F | Ph-4-Cl |

Preference is given to fungicidal mixtures, which comprise, as component a), one of the compounds: I-33, I-35, I-42, I-44, I-46, I-60, or preferably I-18, I-28, I-37, and, as component b), one of the compounds: II-15, II-32, II-62, II-68, or preferably II-59, II-69.

The quantitative ratio of the compounds I and II can be varied within wide ranges; the active compounds are preferably employed in a weight ratio in the range from 20:1 to 1:20, preferably from 10:1 to 1:10, with particular preference from 5:1 to 1:5.

When preparing the mixtures, it is preferred to employ the pure active compounds I and II, to which further active compounds against harmful fungi or other-pests, such as insects, arachnids or nematodes, or else herbicidal or growth-regulating active ingredients or fertilizers can be admixed.

The mixtures of the compounds I and II, or the compounds I and II used simultaneously, jointly or separately, exhibit outstanding activity against a wide range of phytopathogenic fungi, in particular from the classes of the Ascomycetes, Basidiomycetes, Phycomycetes and Deuteromycetes. Some of them act systemically and can therefore be employed as foliar- and soil-acting fungicides.

They are especially important for controlling a large number of fungi in a variety of crop plants, such as cotton, vegetable species (e.g. cucumbers, beans, tomatoes, potatoes and cucurbits), barley, grass, oats, bananas, coffee, maize, fruit species, rice, rye, soya, grapevine, wheat, ornamentals, sugar cane, and a variety of seeds.

They are particularly suitable for controlling the following phytopathogenic fungi: Erysiphe graminis (powdery mildew) in cereals, Erysiphe cichoracearum and Sphaerotheca fuliginea in cucurbits, Podosphaera leucotricha in apples, Uncinula necator in grapevines, Puccinia species in cereals, Rhizoctonia species in cotton, rice and lawns, Ustilago species in cereals and sugar cane, Venturia inaequalis (scab) in apples, Helminthosporium species in cereals, Septoria nodorum in wheat, Botrytis cinera (gray mold) in strawberries, vegetables, ornamentals and grapevines, Cercospora arachidicola in groundnuts, Pseudocercosporella herpotrichoides in wheat and barley, Pyricularia oryzae in rice, Phytophthora infestans in potatoes and tomatoes, Plasmopara viticola in grapevines, Pseudoperonospora species in hops and cucumbers, Alternaria species in vegetables and fruit, Mycosphaerella species in bananas and Fusarium and Verticillium species.

They can furthermore be employed in the protection of materials (for example the protection of wood), for example against Paecilomyces variotii.

The compounds I and II can be applied simultaneously, that is either together or separately, or successively, the sequence, in the case of separate application, generally not having any effect on the result of the control measures.

Depending on the kind of effect desired, the application rates of the mixtures according to the invention are, in particular in agricultural crop areas, from 0.01 to 10 kg/ha, preferably 0.1 to 5 kg/ha, in particular 0.2 to 3.0 kg/ha.

The application rates of the compounds I are from 0.005 to 6.0 kg/ha, preferably 0.08 to 3.0 kg/ha, in particular 0.12 to 2.0 kg/ha.

Correspondingly, in the case of the compounds II, the application rates are from 0.005 to 4.0 kg/ha, preferably 0.02 to 2.0 kg/ha, in particular 0.08 to 1.0 kg/ha.

For seed treatment, the application rates of the mixture are generally from 0.001 to 250 g/kg of seed, preferably 0.01 to 100 g/kg, in particular 0.01 to 50 g/kg.

If phytopathogenic harmful fungi are to be controlled, the separate or joint application of the compounds I and II or of the mixtures of the compounds I and II is effected by spraying or dusting the seeds, the plants or the soils before or after sowing of the plants, or before or after plant emergence.

The fungicidal synergistic mixtures according to the invention or the compounds I and II can be formulated for example in the form of ready-to-spray solutions, powder and suspensions or in the form of highly concentrated aqueous, oily or other suspensions, dispersions, emulsions, oil dispersions, pastes, dusts, materials for broadcasting or granules, and applied by spraying, atomizing, dusting, broadcasting or watering. The use form depends on the intended purpose; in any case, it should ensure as fine and uniform as possible a distribution of the mixture according to the invention.

The formulations are prepared in a known manner, e.g. by extending the active compound with solvents and/or carriers, if desired using emulsifiers and dispersants, it being possible also to use other organic solvents as auxiliary solvents if water is used as the diluent. Suitable auxiliaries for this purpose are essentially: solvents such as aromatics (e.g. xylene), chlorinated aromatics (e.g. chlorobenzenes), paraffins (e.g. mineral oil fractions), alcohols (e.g. methanol, butanol), ketones (e.g. cyclohexanone), amines (e.g. ethanolamine, dimethylformamide) and water; carriers such as ground natural minerals (e.g. kaolins, clays, talc, chalk) and ground synthetic minerals (e.g. finely divided silica, silicates); emulsifiers such as nonionic and anionic emulsifiers (e.g. polyoxyethylene fatty alcohol ethers, alkylsulfonates and arylsulfonates) and dispersants such as lignosulfite waste liquors and methylcellulose.

Suitable surfactants are the alkali metal salts, alkaline earth metal salts and ammonium salts of aromatic sulfonic acids, e.g. ligno-, phenol-, naphthalene- and dibutylnaphthalenesulfonic acid, and of fatty acids, alkyl- and alkylarylsulfonates, alkyl, lauryl ether and fatty alcohol sulfates, and salts of sulfated hexa-, hepta- and octadecanols, or of fatty alcohol glycol ethers, condensates of sulfonated naphthalene and its derivatives with formaldehyde, condensates of naphthalene or of the naphthalenesulfonic acids with phenol and formaldehyde, polyoxyethylene octylphenol ether, ethoxylated isooctyl-, octyl- or nonylphenol, alkylphenyl or tributylphenyl polyglycol ethers, alkylaryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignosulfite waste liquors or methylcellulose.

Powders, materials for broadcasting and dusts can be prepared by mixing or jointly grinding the compounds I or II or the mixture of the compounds I and II with a solid carrier.

Granules (e.g. coated granules, impregnated granules or homogeneous granules) are usually prepared by binding the active compound, or active compounds, to a solid carrier.

Fillers or solid carriers are, for example, mineral earths, such as silicas, silica gels, silicates, talc, kaolin, limestone, lime, chalk, bole, loess, clay, dolomite, diatomaceous earth, calcium sulfate, magnesium sulfate, magnesium oxide, ground synthetic materials and fertilizers, such as ammonium sulfate, ammonium phosphate, ammonium nitrate, ureas, and products of vegetable origin, such as cereal meal, tree bark meal, wood meal and nutshell meal, cellulose powders or other solid carriers.

The formulations generally comprise from 0.1 to 95% by weight, preferably 0.5 to 90% by weight, of one of the compounds I and II or of the mixture of the compounds I and II. The active compounds are employed in a purity of from 90% to 100%, preferably 95% to 100% (according to NMR spectrum or HPLC).

The compounds I or II, the mixtures, or the corresponding formulations, are applied by treating the harmful fungi, their habitat, or the plants, seeds, soils, areas, materials or spaces to be kept free from them with a fungicidally effective amount of the mixture, or of the compounds I and II in the case of separate application.

Application can be effected before or after infection by the harmful fungi.

### USE EXAMPLE

The synergistic activity of the mixtures according to the invention can be demonstrated by the following experiments:

The active compounds, separately or together, are formulated as a 10% emulsion in a mixture of 63% by weight of cyclohexanone and 27% by weight of emulsifier, and diluted with water to the desired concentration.

Evaluation is carried out by determining the infected leaf areas in percent. These percentages are converted into efficacies. The efficacy (W) is calculated as follows using Abbot's formula:

w=(1−α)·100/β

α corresponds to the fungal infection of the treated plants in % and

β corresponds to the fungal infection of the untreated (control) plants in %

An efficacy of 0 means that the infection level of the treated plants corresponds to that of the untreated control plants; an efficacy of 100 means that the treated plants were not infected.

The expected efficacies of the mixtures of the active compounds ere determined using Colby's formula [R. S. Colby, Weeds 15, 20-22 (1967)] and compared with the observed efficacies.

Colby's formula: E=x+y−x·y/100

E expected efficacy, expressed in % of the untreated control, when using the mixture of the active compounds A and B at the concentrations a and b

x efficacy, expressed in % of the untreated control, when using active compound A at a concentration of a

y efficacy, expressed in % of the untreated control, when using active compound B at a concentration of b.

We claim:

1. A fungicidal mixture, comprising
a) benzophenones of the formula I 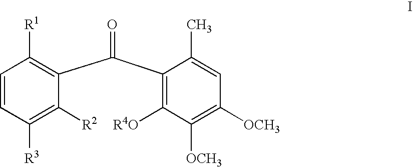
in which
R¹ is chlorine, methyl, methoxy, acetoxy, pivaloyloxy or hydroxyl;
R² is chlorine or methyl;
R³ is hydrogen, halogen or methyl; and
R⁴ is C₁-C₆-alkyl or benzyl, where the phenyl moiety of the benzyl radical may carry a halogen or methyl substituent, and
b) oxime ether derivatives of the formula II 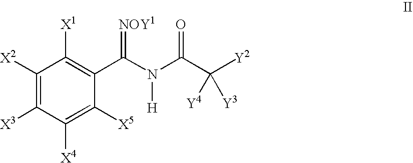
where the substituents X¹ to X⁵ and Y¹ to Y⁴ are as defined below:
X¹ is halogen, C₁-C₄-haloalkyl or C₁-C₄-haloalkoxy;
X² to X⁵ independently of one another are hydrogen, halogen, C₁-C₄-alkyl, C₁-C₄-haloalkyl, C₁-C₄-alkoxy or C₁-C₄-haloalkoxy;
Y¹ is C₁-C₄-alkyl, C₂-C₆-alkenyl, C₂-C₆-alkynyl, C₁-C₄-alkyl-C₃-C₇-cycloalkyl, where these radicals may carry substituents selected from the group consisting of halogen, cyano and C₁-C₄-alkoxy;
Y² is a phenyl radical or a 5- or 6-membered saturated or unsaturated heterocyclyl radical having at least one heteroatom selected from the group consisting of N, O and S, where the cyclic radicals may have one to three substituents selected from the group consisting of halogen, C₁-C₄-alkyl, C₁-C₄-alkoxy, C₁-C₄-haloalkyl, C₁-C₄-haloalkoxy, C₁-C₄-alkoxy-C₂-C₄-alkenyl, C₁-C₄-alkoxy-C₂-C₄-alkynyl;
Y³, Y⁴ independently of one another are hydrogen, C₁-C₄-alkyl, C₁-C₄-alkoxy, C₁-C₄-alkylthio, N-C₁-C₄-alkylamino, C₁-C₄-haloalkyl or C₁-C₄-haloalkoxy;
in a synergistically effective amount.

2. A fungicidal mixture as claimed in claim 1, where in formula I
R¹ is methoxy, acetoxy or hydroxyl;
R² is methyl;
R³ is hydrogen, chlorine or bromine; and
R⁴ is C₁-C₄-alkyl.

3. A fungicidal mixture as claimed in claim 1, wherein the weight ratio of the benzophenones I to the oxime ether derivatives of the formula II is from 20:1 to 1:20.

4. A method for controlling harmful fungi, which comprises treating the harmful fungi, their habitat or the plants, seeds, soils, areas, materials or spaces to be kept free from them with benzophenones of the formula I as set forth in claim 1 and oxime ether derivatives of the formula II as set forth in claim 1.

5. A method as claimed in claim 4, wherein benzophenones of the formula I as set forth in claim 1 and oxime ether derivatives of the formula II as set forth in claim 1 are applied simultaneously, that is either together or separately, or successively.

6. A method as claimed in claim 4 or 5, wherein the benzophenones of the formula I as set forth in claim 1 are applied in an amount of from 0.08 to 3.0 kg/ha.

7. A method as claimed in any of claims 4 to 6, wherein the oxime ether derivatives of the formula II as set forth in claim 1 are applied in an amount of from 0.02 to 2.0 kg/ha.

8. A fungicidal composition, which is conditioned in two parts, one part comprising benzophenones of the formula I as set forth in claim 1 in a solid or liquid carrier and the other part comprising oxime ether derivatives of the formula II as set forth in claim 1 in a solid or liquid carrier.
